(19) United States
(12) Patent Application Publication
(10) Pub. No.: US 2015/0270582 A1
(43) Pub. Date: Sep. 24, 2015

(54) SECONDARY BATTERY

(71) Applicant: SAMSUNG SDI CO., LTD., Yongin-si (KR)

(72) Inventors: Hyun-Chul KIM, Yongin-si (KR); Hyun SOH, Yongin-si (KR)

(21) Appl. No.: 14/619,580

(22) Filed: Feb. 11, 2015

(30) Foreign Application Priority Data
Mar. 19, 2014 (KR) 10-2014-0032079

(51) Int. Cl. H01M 10/42; H01M 4/583; H01M 4/62

(52) U.S. Cl. CPC H01M 10/4235; H01M 4/62; H01M 4/583

(57) ABSTRACT

A secondary battery includes an electrode assembly that includes a first electrode plate including a first base material and a coating of a first active material on at least a portion of the first base material, a second electrode plate including a second base material and a coating of a second active material on at least a portion of the second base material, a separator between the first and second base materials, and an expansion member in at least one of the first and second base materials.

### CROSS-REFERENCE TO RELATED APPLICATION

Korean Patent Application No. 10-2014-0032079, filed on Mar. 19, 2014, in the Korean Intellectual Property Office, and entitled: “Secondary Battery,” is incorporated by reference herein in its entirety.

### BACKGROUND

1. Field

Embodiments relate to a secondary battery.

2. Description of the Related Art

As industries of electronics, communications and the like have developed, the spread of portable electronic devices such as camcorders, cellular phones and notebook PCs has increased. Accordingly, the use amount of secondary batteries has also increased. Secondary batteries can be used not only for portable electronic devices but also for medium- and large-sized apparatuses such as electric tools, automobiles, a space transportation systems, motorbikes, motor scooters, and an aerial transportation systems, which require high output and high power. Therefore, high-capacity and high-power secondary batteries are essentially used as batteries of the medium- and large-sized apparatuses.

### SUMMARY

Embodiments are directed to a secondary battery including an electrode assembly that includes a first electrode plate including a first base material and a coating of a first active material on at least a portion of the first base material, a second electrode plate including a second base material and a coating of a second active material on at least a portion of the second base material, a separator between the first and second base materials, and an expansion member in at least one of the first and second base materials.

The first or second base material may be a sheet-shaped conductive material.

A surface of the at least one of the first and second base materials may include a first accommodating portion having the expansion member accommodated therein.

The first accommodating portion may be inwardly recessed from the exterior of the surface of the at least one of the first and second base materials.

A second accommodating portion having the expansion member accommodated therein may be inside the at least one of the first and second base materials.

The second accommodating portion may have a shape of a pore corresponding to a size of the expansion member inside the at least one of the first and second base materials.

The first active material may be a positive electrode active material including a lithium compound. The second active material may be a negative electrode active material including carbon.

The expansion member may include an azide. The azide may be sodium azide (NaN₃).

The first electrode plate may include a first active material coating portion on which the first active material is coated and a first non-coating portion on which the first active material is not coated. The second electrode plate may include a second active material coating portion on which the second active material is coated and a second non-coating portion on which the second active material is not coated. The expansion member may be in at least one of the first and second active material coating portions.

A surface roughness may be formed on the at least one of the first and second base materials.

The secondary battery may further include a battery case that accommodates the electrode assembly therein, and an electrolyte in the battery case. The electrolyte may be physically and chemically coupled to an outer surface of the second electrode plate of the electrode assembly.

### BRIEF DESCRIPTION OF THE DRAWINGS

Features will become apparent to those of skill in the art by describing in detail exemplary embodiments with reference to the attached drawings in which:

FIG. 1 illustrates a partially exploded perspective view of a secondary battery according to an embodiment.

FIG. 2 illustrates a partially exploded perspective view of components of the electrode assembly of the secondary battery of FIG. 1.

FIG. 3 illustrates a perspective view of a first electrode plate of FIG. 2.

FIG. 4 illustrates a sectional view taken along line A-A′ of FIG. 3 according to an embodiment.

FIG. 5 illustrates a sectional view taken along line A-A′ of FIG. 3 according to another embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

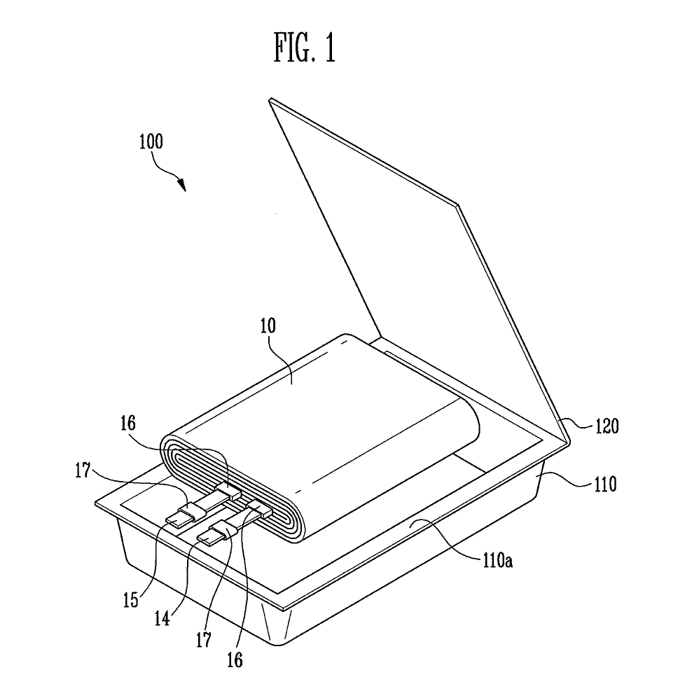

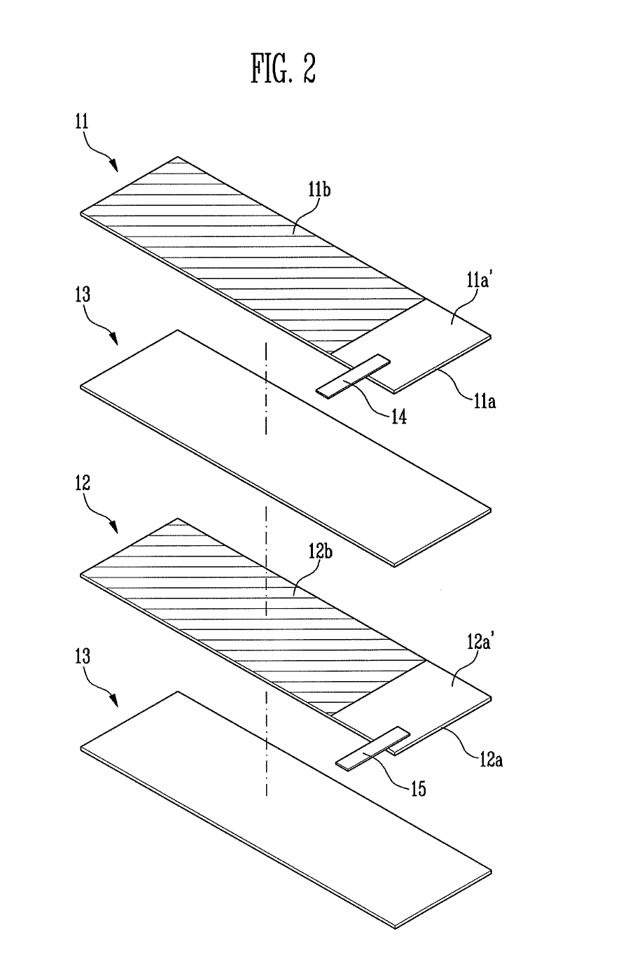

FIG. 1 illustrates a partially exploded perspective view of a secondary battery according to an embodiment. FIG. 2 illustrates a partially exploded perspective view of components of the electrode assembly the secondary battery of FIG. 1.

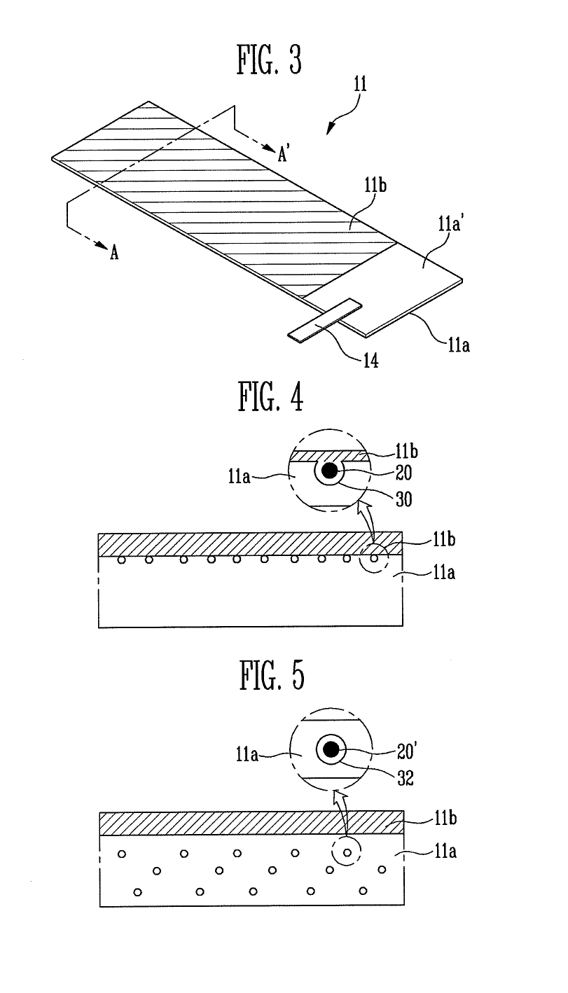

As shown in FIGS. 1 and 2, the secondary battery 100 according to this embodiment may include an electrode assembly 10, a battery case 110 and 120, and an electrolyte. The electrode assembly 10 may include a first electrode plate 11 formed by coating a first active material on at least a portion of a first base material 11a, a second electrode plate 12 formed by coating a second active material on at least a portion of a second base material 12a, and a separator 13 interposed between the first and second electrode plates 11 and 12. The battery case 110 and 120 may accommodate the electrode assembly 10 therein. The electrolyte may be accommodated in the battery case 110 and 120 to be physically and chemically coupled to an outer surface of the second electrode plate of the electrode assembly. An expansion member 20 (see FIGS. 4 and 5) may be provided in at least one of the first and second base materials 11a and 12a.

The secondary battery 100 may be manufactured by accommodating, inside the battery case 110 and 120, the electrode assembly 10 configured with the first and second electrode plates 11 and 12 having different polarities from each other and the separator 13 provided to prevent the first and second electrode plates 11 and 12 from being short-circuited by coming in direct contact with each other, and the electrolyte enabling ions to move between the first and second electrode plates 11 and 12. The electrode assembly 10 may be manufactured in a jelly roll (J/R) form by winding the first and second electrode plates 11 and 12 and the separator 13, which are laminated to each other, or be manufactured in a stack form by stacking a plurality of first and second electrode plates 11 and 12 and a plurality of separator 13. In some implementations, the electrode assembly 10 may be manufactured using both the winding and stacking processes. According to embodiments, the electrode assembly 10 may be manufactured in various forms. Hereinafter, the electrode assembly 10 manufactured in the J/R form by winding the first and second electrode plates 11 and 12 and the separator 13 will be mainly described.

The first electrode plate 11 may include a first active material coating portion 11b formed by intermittently coating a first active material on the first base material 11a, which may be a sheet-shaped conductive material, and a first non-coating portion 11a′, which is a portion at which the first active material is not coated such that the first base material 11a is exposed. A first electrode tab 14 made of a metal such as nickel may be provided to the first non-coating portion 11a′. For example, the first electrode plate 11 may be a positive electrode plate, and the first active material may be a positive electrode active material including lithium, such as LiCoO₂, LiNiO₂, LiMnO₂, LiMn₂O₄ or LiNi_{1-x-y}CoₓM_{y}O₂.

The second electrode plate 12 has a different polarity from the first electrode plate 11. The second electrode plate 12 may include a second active material coating portion 12b formed by intermittently coating a second active material on the second base material 12a, which may be a sheet-shaped conductive material, and a second non-coating portion 12a′, which is a portion at which the second active material is not coated such that the second base material 12a is exposed. A second electrode tab 15 made of a metal such as nickel may be provided to the second non-coating portion 12a′. For example, the second electrode plate 12 may be a negative electrode plate, and the second active material may be a negative electrode active material including a carbon material such as crystalline carbon, amorphous carbon, carbon composite or carbon fiber, lithium metal, or lithium alloy.

The separator 13 may be positioned between the first and second electrode plates 11 and 12 to be wound, and may insulate the first and second electrode plates 11 and 12 from each other. The separator 13 may enable lithium ions to be exchanged between the first and second electrode plates 11 and 12. The separator 13 may be formed to a sufficient length to completely insulate between the first and second electrode plates 11 and 12 even when the electrode assembly 10 is contracts and expands.

The first or second base material 11a or 12a may act as a collector of current or electrons, and may include a thin-film shaped metal. For example, the first base material 11a may include aluminum, and the second base material 12a may include copper. The first and second electrode plates 11 and 12 may discharge ions into the electrolyte to generate a flow of current or electrons. The current or electrons may be transferred to an outside of the electrode assembly 10 through the first and second electrode tabs 14 and 15. The first electrode tab 14 may be a positive electrode tab, and the second electrode tab 15 may be a negative electrode tab.

The electrolyte may be provided to allow ions or electric charges to easily move between the first and second electrode plates 11 and 12. The electrolyte may include a lithium salt acting as a supply source of lithium ions, and a non-aqueous organic solvent acting as a medium through which ions participating in an electrochemical reaction may move.

The first and second electrode tabs 14 and 15 may be extracted to the outside of the electrode assembly 10. The battery case 110 and 120 may include an accommodating portion 110, one surface of which is opened to accommodate the electrode assembly 10 and the electrolyte, and a cover portion 120 formed at one side of the accommodating portion 110 to cover the one surface of the accommodating portion 110. A portion 110a at which the accommodating portion 110 and the cover portion 120 come in contact with each other may be sealed.

A lamination tape 16 may be wound around a portion at which the first or second electrode tab 14 or 15 is extracted from the electrode assembly 10. The lamination tape 16 may block heat generated in the first or second electrode tab 14 or 15, and may prevent the electrode assembly 10 from being pressed by an edge of the first or second electrode tab 14 or 15.

An insulating tape 17 may be adhered to a surface of the first or second electrode tab 15 contacted with the battery case 110 and 120 such that a portion of the insulating tape 17 protrudes to the outside of the battery case 110 and 120. In this embodiment, the secondary battery 100 may be a pouch-type secondary battery.

FIG. 3 illustrates a perspective view of a first electrode plate of FIG. 2. FIG. 4 illustrates a sectional view taken along line A-A′ of FIG. 3 according to an embodiment.

As shown in FIG. 3, the first electrode plate 11 may include a first active material coating portion 11b formed by intermittently coating a first active material on the sheet-shaped first base material 11a, and a first non-coating portion 11a′, which is a portion on which the first active material is not coated such that the first base material 11a is exposed. A first electrode tab 14 made of a metal such as nickel may be provided to the first non-coating portion 11a′.

Only the first electrode plate 11 is shown in FIGS. 3 and 4, but it is to be understood that in some implementations, the description of the first electrode plate 11 may also be applied to the second electrode plate 12. In other implementations, the description herein may apply to the second electrode plate 12 and not to the first electrode plate 11. The description may apply to at least one of the first electrode plate 11 and the second electrode plate 12. Therefore, the first and second electrode plates 11 and 12 will be described together.

The first or second base material 11a and 12a, as shown in FIG. 4, may be provided with a first accommodating portion 30 disposed at the first or second active material coating portion 11b or 12b, specifically a position that overlaps with the first or second active material coating portion 11 b or 12b. The first accommodating portion 30 may be inwardly recessed from an outer surface of the first or second base material 11a or 12a to accommodate an expansion member 20 therein. The expansion member 20 may be made of an azide, such as sodium azide (NaN₃). An azide such as sodium azide is a material having excellent reactivity and expandability, having has a reaction speed of 20 to 300 ns (0.01 to 0.3 second), a reaction temperature of 200 to 700° C., a reaction pressure of 20 to 35 atm and a reaction expansion rate of 600 times. In addition, the azide may be safe because it does not react under general operating conditions, and a side reaction caused by generation of nitrogen gas may not additionally occur.

The expansion member 20 may be coated with polyethylene (PE).

A surface roughness may be formed on the first or second base material 11a or 12a.

FIG. 5 illustrates a sectional view taken along line A-A′ of FIG. 3 according to another embodiment.

The section taken along line A-A′ of the first electrode plate 11 is shown in FIG. 5, but it is to be understood that the description of the first electrode plate may also be applied to the second electrode plate 12. Therefore, the first and second electrode plates 11 and 12 will be described together.

As shown in FIG. 5, the first electrode plate 11 may include a first active material coating portion 11b formed by intermittently coating a first active material on the sheet-shaped first base material 11a, and a first non-coating portion 11a′, which is a portion on which the first active material is not coated such that the first base material 11a is exposed. A first electrode tab 14 made of a metal such as nickel may be provided to the first non-coating portion 11a′.

The first or second base material 11a or 12a may be provided with a second accommodating portion 32 disposed at a position that overlaps with the first or second active material coating portion 11b or 12b. The second accommodating portion 32 may be formed in the shape of a pore corresponding to the size of an expansion member 20′ of the first or second base material 11a or 12a, to accommodate the expansion member 20′ therein. The expansion member 20′ may be made of an azide including sodium azide (NaN₃). An azide such as sodium azide is a material having excellent reactivity and expandability, a reaction speed of 20 to 300 ns (0.01 to 0.3 second), a reaction temperature of 200 to 700° C., a reaction pressure of 20 to 35 atm, and a reaction expansion rate of 600 times. In addition, the azide may be safe because it does not react under general operating conditions. A side reaction caused by generation of nitrogen gas may not additionally occur.

The expansion member 20′ may be coated with polyethylene (PE).

A surface roughness may be formed on the first or second base material 11a or 12a.

By way of summation and review, as the energy density of a battery increases, the safety of the battery may be lowered. In a high-capacity prismatic battery, the amount of heat generated by the penetration of the interior of the battery may be large, and heat dissipation of the battery may difficult. As a result, thermal runaway may be caused in the battery.

Embodiments provide a secondary battery having first and second base materials provided with an expansion member. Embodiments also provide a secondary battery having a structure in which the safety of the secondary battery is improved with respect to the generation of heat or the occurrence of a short circuit. Embodiments also provide a secondary battery having an accommodating portion for accommodating an expansion member. Embodiments also provide a secondary battery having a structure for closely accommodating expansion members.

As described above, according to the secondary battery, the expansion member may be provided in the first and second base material. The expansion member may generate gas such that when an internal or external short circuit is caused by overcharging of the secondary battery, penetration of a nail into the secondary battery, or the like, the expansion member provided in the first or second electrode plate may expand to tear the electrode plate. Thus, it may be possible to prevent the transfer of energy, caused due to the short circuit, thereby improving the safety of the secondary battery.

Further, the accommodating portion for accommodating the expansion member therein may be provided in the first or second base material. Thus, it may be unnecessary to manufacture a separate safety member, thereby reducing the manufacturing cost of the secondary battery.

Further, the secondary battery may have a structure in which the expansion member is included in the first or second base material. Thus, the manufacturing of the secondary battery may be simplified. The assembling of the secondary battery may also easy, thereby improving the operating efficiency of the secondary battery.

The expansion member may have a reaction speed of 0.01 to 0.3 seconds, which is very fast. Thus, a portion at which a short circuit occurs in the secondary battery may be quickly removed. Accordingly, a chain reaction caused by a side reaction of nitrogen gas may be prevented in advance.

As described above, in the secondary battery, the expansion member may be provided in at least one of the first and second base material, such that when an internal or external short circuit is caused by overcharging of the secondary battery, penetration of a nail into the secondary battery, or the like, the expansion member provided in the first or second electrode plate may expand to tear the electrode plate. Thus, it may be possible to prevent the transfer of energy caused due to the short circuit, thereby improving the safety of the secondary battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A secondary battery, comprising an electrode assembly that includes:
a first electrode plate including a first base material and a coating of a first active material on at least a portion of the first base material;
a second electrode plate including a second base material and a coating of a second active material on at least a portion of the second base material;
a separator between the first and second base materials, and
an expansion member in at least one of the first and second base materials.

2. The secondary battery as claimed in claim 1, wherein the first or second base material is a sheet-shaped conductive material.

3. The secondary battery as claimed in claim 1, wherein a surface of the at least one of the first and second base materials includes a first accommodating portion having the expansion member accommodated therein.

4. The secondary battery as claimed in claim 3, wherein the first accommodating portion is inwardly recessed from an exterior of the surface of the at least one of the first and second base materials.

5. The secondary battery as claimed in claim 1, wherein a second accommodating portion having the expansion member accommodated therein is inside the at least one of the first and second base materials.

6. The secondary battery as claimed in claim 5, wherein the second accommodating portion has a shape of a pore corresponding to a size of the expansion member inside the at least one of the first and second base materials.

7. The secondary battery as claimed in claim 1, wherein:
the first active material is a positive electrode active material including a lithium compound, and
the second active material is a negative electrode active material including carbon.

8. The secondary battery as claimed in claim 1, wherein the expansion member includes an azide.

9. The secondary battery as claimed in claim 8, wherein the azide is sodium azide (NaN₃).

10. The secondary battery as claimed in claim 1, wherein:
the first electrode plate includes a first active material coating portion on which the first active material is coated and a first non-coating portion on which the first active material is not coated,
the second electrode plate includes a second active material coating portion on which the second active material is coated and a second non-coating portion on which the second active material is not coated, and
the expansion member is in at least one of the first and second active material coating portions.

11. The secondary battery as claimed in claim 1, wherein a surface roughness is formed on the at least one of the first and second base materials.

12. The secondary battery as claimed in claim 1, further comprising:
a battery case that accommodates the electrode assembly therein; and
an electrolyte in the battery case, the electrolyte being physically and chemically coupled to an outer surface of the second electrode plate of the electrode assembly.
